(19) United States
(12) Patent Application Publication
(10) Pub. No.: US 2014/0181630 A1
(43) Pub. Date: Jun. 26, 2014

(54) METHOD AND APPARATUS FOR ADDING ANNOTATIONS TO AN IMAGE

(71) Applicant: VIDINOTI SA, Fribourg (CH)

(72) Inventors: Mathieu MONNEY, Lausanne (CH); Laurent Rime, Fribourg (CH); Serge Ayer, Farvagny (CH)

(73) Assignee: Vidinoti SA, Fribourg (CH)

(21) Appl. No.: 13/724,423

(22) Filed: Dec. 21, 2012

(51) Int. Cl. G06F 17/24

(52) U.S. Cl. CPC G06F 17/241
USPC 715/232

(57) ABSTRACT

A method comprising the steps of:
retrieving data (100) representing a light field with a plenoptic capture device (4);
executing program code for matching the retrieved data with corresponding reference data (101);
executing program code for retrieving at least one annotation (61, 63, 64) in a plenoptic format associated with an element of said reference data (102);
executing program code for generating annotated data in a plenoptic format from said retrieved data and said annotation (103).

This application is related to U.S. patent application Ser. No. 13/645,762 filed on Oct. 5, 2012, the contents of which is incorporated by reference.

### BACKGROUND OF THE INVENTION

The present invention relates to augmented reality methods and apparatus, in particular to a method and to various apparatus for adding annotations to data corresponding to a scene.

Rapid progress in the development of hand-held portable devices such as smartphones, palmtop computers, portable media players, personal-digital-assistant (PDA) devices and the like, has led to inclusion of novel features and applications involving image processing. For example, augmented-reality applications are known where a user points a portable device towards a scene, e.g. a landscape, a building, a poster, or a painting in a museum, and the display shows the image together with superimposed information concerning the scene. Such information can include names, e.g. for mountains and habitations, people names, historical information for buildings, and commercial information such as advertising, e.g. a restaurant menu. An example of such a system is described in EP1246080 and in EP2207113.

It is known to supply annotation information to portable devices by servers in a wireless communication network. Annotation systems including a communication network with servers and portable devices are also known, as well as annotation methods.

Many annotation methods include a step of comparing an image, such as a 2D image produced by a standard pin-hole camera with a standard CCD or CMOS sensor, or a computer generated image, with a set of reference images stored in a database. As actual viewing angle and lighting conditions can be different with respect to the images stored in the database, an aim of the comparison algorithm is to remove the influence of these parameters.

For example, WO2008134901 describes a method where a first image is taken using a digital camera associated with a communication terminal. Query data related to the first image is transmitted via a communication network to a remote recognition server, where a matching reference image is identified. By replacing a part of the first image with at least a part of the annotated image, an augmented image is generated and displayed at the communication terminal. The augmentation of the first image taken with the camera occurs in the planar space and deals with two-dimensional images and objects only.

Light ray information, such as the direction of light rays in each point of space, is discarded in conventional image annotation systems. Annotation without light ray information makes a realistic view of the annotated scene more difficult. For example, capturing or displaying a texture on the surface of an object requires light ray information. Though each object has a different texture on its surface, it is not possible to add in texture information in current annotation systems. This results in attached annotations not realistically integrated in the scene.

Moreover, the rapid growth of augmented-reality applications may cause flood of annotations in the future. Some scenes, for example in cities, contain many elements associated with different annotations, resulting in annotated images with a very large number of annotations covering large portions of the background image. In many situations, the user is only interested in a limited number of those annotations, and the other ones are just distracting. Therefore, it would often be desirable to limit the number of annotations and to provide a way of selecting the annotations which should be displayed.

Furthermore, computational expense is a crucial problem for annotated scene viewing. Reduction of the computational expense would be demanded.

It is therefore an aim of the present invention to solve or at least mitigate the above mentioned problems of existing augmented reality systems.

### BRIEF SUMMARY OF THE INVENTION

According to the invention, these aims are achieved by way of a method comprising the steps of:

retrieving data representing a light field with a plenoptic capture device;

executing program code for matching the captured data with corresponding reference data;

executing program code for retrieving an annotation in a plenoptic format associated with an element of said reference data;

executing program code for generating annotated data from said captured data and said annotation in a plenoptic format.

The invention is also achieved by way of an apparatus for capturing and annotating data corresponding to a scene, comprising:

a plenoptic capturing device for capturing data representing a light field;

a processor;

a display;

programme code for causing said processor to retrieve at least one annotation in a plenoptic format associated with an element of data captured with said plenoptic capturing device and for rendering on said display a view generated from the captured data and including said at least one annotation when said program code is executed.

The invention also provides an apparatus for determining annotations, comprising:

a processor;

a store;

program code for causing said processor to receive data representing a light field, to match said data with one reference data, to determine an annotation from said store in plenoptic format associated with said reference data, and to send either said annotation in plenoptic format or data corresponding to an annotated image in plenoptic format to a remote device when said program code is executed.

The claimed addition of annotations in a plenoptic format permits a more realistic integration of the annotation in the image in plenoptic format; the annotation seems to be an element of the captured scene, instead of just a text superimposed over an image. An annotation in a plenoptic format (also called “plenoptic annotation” in the present application) contains a more complete description of the light field than a conventional annotation, including information of how light rays are modified.

The provision of annotations in a plenoptic format also permits a selection of the annotation that should be displayed, depending on a focus distance and/or on a viewpoint selected by the user during the rendering of the image, or automatically selected, for example based on his interests.

Since the annotations are in the same space (i.e. the plenoptic space) than the captured data, the computation expense for the annotation process is reduced.

In particular, the computational expense for rendering the plenoptic data in a human understandable format is reduced. Indeed, since the image in plenoptic format and the plenoptic annotation lie in the same space, the rendering process is identical for both. In one embodiment, a single rendering process can be used for rendering the images and the associated annotations. In this case, the projection parameters selected for the plenoptic rendering process (such as selection of focus, depth, change of view point, . . . ) also apply on plenoptic annotations. For example, when changing the focus or viewpoint of a plenoptic image, the same transformation can be used for displaying the plenoptic annotations at various distances. In another embodiment, the effect of the annotation is applied to the captured plenoptic image, and a rendering of the modified plenoptic image is performed.

Therefore, a plenoptic annotation, i.e., an annotation in plenoptic format, provides a realistic way of displaying annotations, permits more types of annotation including textured annotations and enhances computational efficiency.

Unlike conventional annotations, a plenoptic annotation may contain as much information about light rays as images captured by plenoptic capturing device. Thus, it is possible to synthesize the annotation directly in the captured light field without losing the light ray information caused by projection onto 2D image. For example, the annotation can retain the characteristics of light reflection on the surface of an annotated object which is not possible with a conventional annotation system. In this sense, annotated views seem more realistic.

The direct modification of light rays can facilitate the computation, such as simultaneous generation of annotated scenes from multiple viewpoints. In the example of annotated scene generation, annotation processing and other extra-processing on the scene, such as blurring or sharpening, are applied once in plenoptic format directly instead of attaching annotations and applying extra-processing on a generated 2D image for each view point. Hence, synthesis of a plenoptic image and a plenoptic annotation directly in the plenoptic format may result in reduction of computational expense.

The present invention also relates to a method for attaching annotations to a reference image in plenoptic format, comprising:

presenting said reference image in a plenoptic format with a viewer;

selecting an annotation;

selecting with said viewer a position for said annotation and one or a plurality of directions from which said annotation can be seen;

associating in a memory said position and said directions with said annotation and said reference image in plenoptic format.

This method may be carried out with a suitable authoring system, such as a suitable software application or web site.

### BRIEF DESCRIPTION OF THE DRAWINGS

The invention will be better understood with the aid of the description of an embodiment given by way of example and illustrated by the figures, in which:

FIG. 1 schematically illustrates a plenoptic capturing device for capturing data representing a light field of scene with an object at a first distance.

FIG. 2 schematically illustrates a plenoptic capturing device for capturing data representing a light field of scene with an object at a second distance.

FIG. 3 schematically illustrates a plenoptic capturing device for capturing data representing a light field of scene with an object at a third distance.

FIG. 4 schematically illustrates a system comprising various apparatus elements that together embody the invention.

FIGS. 5A to 5B show annotated views rendered from the same plenoptic data, wherein the viewpoint selected by the user during the rendering has changed between the two views, resulting in a same annotation rendered in a different way.

FIGS. 6A to 6B show annotated views rendered from the same plenoptic data, wherein the viewpoint selected by the user during the rendering has changed between the two views, resulting in a first annotation made visible on the first view and a second annotation made visible on the second view.

FIGS. 7A to 7B show annotated views rendered from the same plenoptic data, wherein the focusing distance selected by the user during the rendering has changed between the two views, resulting in a first annotation made visible on the first view and a second annotation made visible on the second view.

FIG. 8 is a block diagram of a method for generating and rendering a view with annotations in plenoptic format.

FIG. 9 is a block diagram of a method for modifying the rendering of annotations when the viewer selects a different viewing direction and/or a different focusing distance on a view.

FIG. 10 is a block diagram of a method for associating an annotation in a plenoptic format with a reference data.

FIG. 11 is a block diagram of a method of continuous annotation of a series of plenoptic images, such as video plenoptic images or plenoptic images captured by a user in movement.

### DETAILED DESCRIPTION OF POSSIBLE EMBODIMENTS OF THE INVENTION

Conventional cameras capture a 2D projection of a scene on a sensor, and generate data indicating the intensity of light on each pixel with or without color. On the other hand, plenoptic capturing devices, which are known as such, capture a data representing the light field, i.e. a matrix indicating not only the intensity of light, but also more complete information about the light field including the direction of light.

A complete light field may comprise up to 7 parameters for describing each light ray (or for describing the light rays at a given position): 3 for the position, 2 for the direction, 1 for the wavelength and (in the case of video) 1 for the time. Some current plenoptic cameras deliver plenoptic data comprising 2 parameters for the position, 2 for the direction, and one for the wavelength. Sensors generate plenoptic data representing a so-called plenoptic light field, i.e., a matrix indicating at least the position and the direction of the light rays. It means that plenoptic data generated by a plenoptic capturing device contains more information about the light field than a conventional 2D image data generated by a conventional 2D camera.

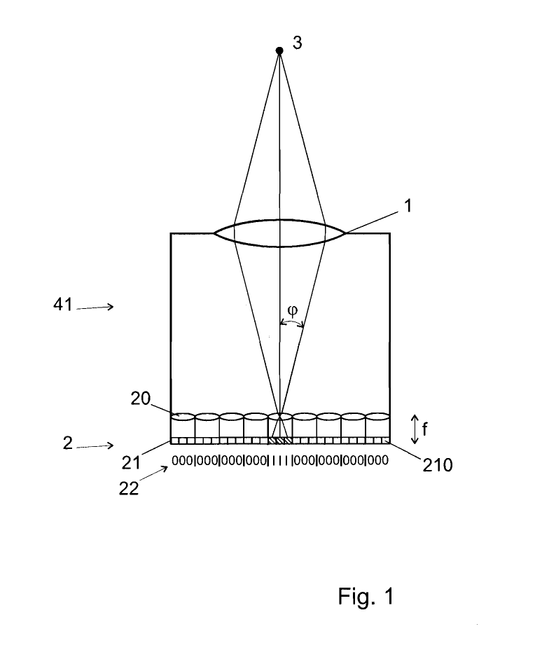

As of today, at least two companies propose plenoptic sensors that can record such a plenoptic light field: Lytro and Raytrix. Their two cameras are slightly different in terms of design, but the main idea is to decompose the different directions of the light that is supposed to fall on a single photosite (or pixel) in a standard camera sensor. To that aim, as illustrated on FIG. 1, an array of micro-lenses 20 is placed behind the main lens 1, in place of the sensor of conventional cameras.

That way, the micro-lenses 21 redirect the light rays according to their incident angle and the redirected light rays reach different pixels 210 of the sensor 21. The amount of light measured by each of the N×M pixels 210 making a sub image depends on the direction of the light beams that hit the micro-lens 20 in front of that sub image.

FIGS. 1 to 3 illustrate a simple one-dimensional sensor comprising n=9 sub images, each sub image having one row of N×M pixels (or photosites) 210, N being equal to 3 and M to 1 in this example. Many plenoptic sensors have a higher number of sub-images and a higher number of pixels for each sub image, for example 9×9 pixels, allowing to distinguish between N×M=81 different orientations of light on the micro-lens 20. Assuming that all objects of the scene are in focus, each sub image thus includes a patch of brightness values indicating the amount of light coming from various directions onto that sub-image.

In this construction, the array of micro-lenses 20 is located on the image plane formed by the main lens 1 of the plenoptic capturing device, and the sensor 21 is located at a distance f from the micro-lenses, where f is the focal length of the micro-lenses. This design allows a high angular resolution but suffers from relatively poor spatial resolution (the effective number of pixels per rendered image is equal to the number of micro-lenses). This problem is addressed by other plenoptic capturing devices where the micro-lenses focus on the image plane of the main lens, thus creating a gap between the micro-lenses and the image plane. The price to pay in such a design is poorer angular resolution.

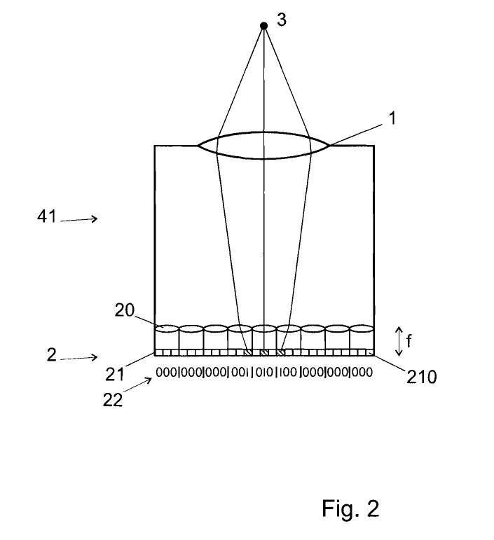

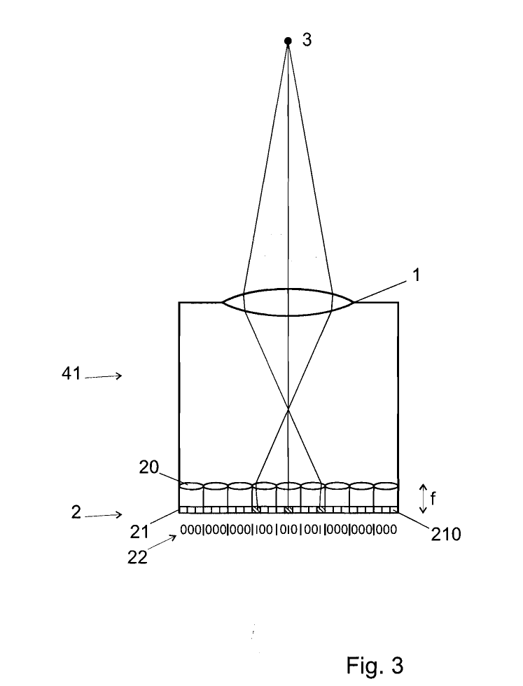

As can be observed on FIGS. 1 to 3, the plenoptic light field corresponding to a scene with a single point 3 in this example depends on the distance from the point 3 to the main lens 1. On FIG. 1, all the light beams from this object reach the same micro-lens 20, thus resulting in a plenoptic light field where all the pixels in the sub-image corresponding to this micro-lens record a first positive light intensity while all other pixels corresponding to other lenses record a different, null light intensity. On FIG. 2, where the object 3 is closer to the lens 1, some light beams originating from the point 3 reach pixels of other sub images, i.e., sub images associated with two micro-lenses adjacent to the previously hit micro-lens. On FIG. 3, where the object 3 is at a greater distance from the lens 1, some light beams originating from the point 3 reach different pixels associated with two micro-lenses adjacent to the previously hit micro-lens. Therefore, the digital data 22 delivered by the sensor 21 depends on the distance to the object 3.

The plenoptic sensor 21 thus delivers plenoptic data 22 containing, for each sub image corresponding to a micro-lens 20, a set of (N×M) values indicating the amount of light coming from various directions on the lens above this sub image. For a given focused object point, each pixel of a sub image corresponds to the intensity measure of a light ray hitting the sensor with a certain incidence angle phi (in the plane of the page) and theta (perpendicular to the plane of the page).

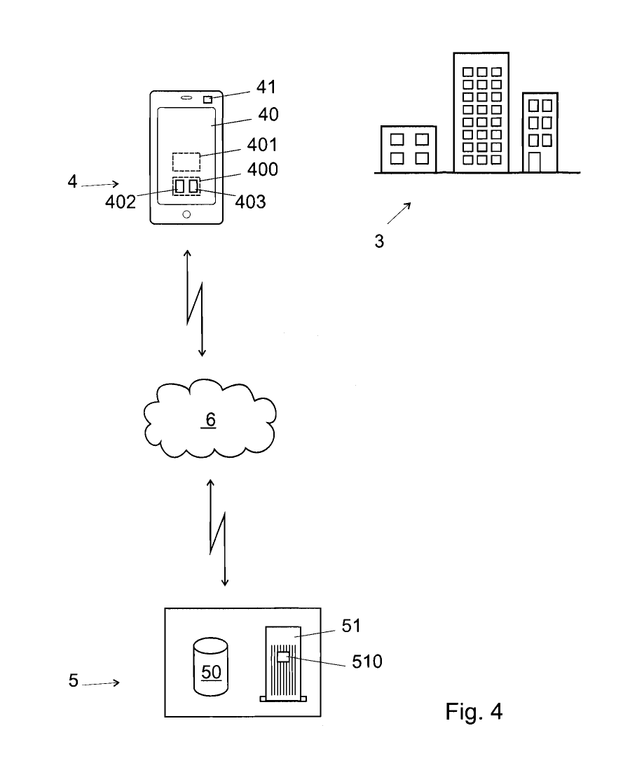

FIG. 4 schematically illustrates a block diagram of an annotation system embodying the invention. The system comprises a user device 4, such as a hand-held device, a smartphone, a tablet, a camera, glasses, goggles, contact lenses, etc. The device 4 includes a plenoptic capturing device 41 such as the camera illustrated in FIGS. 1 to 3, for capturing data representing a light field on a scene 3, a processor such as a microprocessor 400 with a suitable program code, and a communication module 401 such as a WIFI and/or cellular interface for connecting the device 4 to a remote server 5, for example a cloud server, over a network such as the Internet 6. The server 5 includes a storage 50 with a database such as a SQL database, a set of XML documents, a set of images in plenoptic format, etc, for storing a collection of reference plenoptic data representing images and/or one or a plurality of global models, and a processor 51, including a microprocessor with computer code for causing the microprocessor to perform the operations needed in the annotation method. The annotations and corresponding positions can also be stored in storage 50 along with the reference plenoptic data.

The program code executed by the user device 4 could include for example an application software, or app, that can be downloaded and installed by the user in the user device 4. The program code could also include part of the operating code of the user device 4. The program code could also include code embedded in web page or executed in a browser, including for example Java, Javascript, HTML5 code, etc. The program code may be stored as a computer program product in a tangible apparatus readable medium, such as a Flash memory, a hard disk, or any type of permanent or semi-permanent memory.

The program code is executed by the microprocessor 400 in the user device 4 for causing this microprocessor to send at least some of the captured data sets corresponding to light fields, or features of those data sets, to the remote server 5. The program code is arranged for sending the data in a “plenoptic format”, i.e., without losing the information about the direction of the light rays. The program code can also cause the microprocessor 400 to receive from the server 5 annotated data in a plenoptic format, or annotated images, or annotations related to the previously sent plenoptic data, and for rendering a view corresponding to the captured data with annotations.

The plenoptic annotation method may comprise two parts: an offline process and an online process. Generally, the main purpose of the offline process is to associate annotations with reference images in a plenoptic format, or with other 2D, stereoscopic, or 3D reference images.

### Offline Phase

In the case of reference images in a plenoptic format, the offline process may comprise for example the following steps:
1. receiving from the device 4 reference data in a plenoptic format and representing a light field;
2. presenting a rendered view of the plenoptic reference image, for example with a plenoptic viewer;
3. selecting a plenoptic annotation,
4. selecting a position and orientation for the annotation in the rendered view,
5. selecting one or plurality of light field parameters of the annotation,
6. (optionally) attributing an action to the annotation,
7. associating in a memory the reference image light rays with the annotation light rays based on its position and orientation.

This offline process can be performed either on the server 5, in the user device 4, or in yet another equipment such as a personal computer, a tablet, etc. Typically, this offline process is executed only once for each annotation associated with the reference image. If the selected annotation is initially not available in a plenoptic format, it may be converted into a plenoptic format.

The main purpose of the online process is to add plenoptic annotations to plenoptic images. The online process may comprise two phases. The first one may be carried out by a program code executed by a microprocessor in the server 5, which may include executable programs or other codes for causing the server 5 to carry out at least some of the following tasks:
1. receiving from a device 4 data in a plenoptic format and representing a light field;
2. retrieving from a database 50 a previously stored model (reference image) and/or a plurality of reference data;
3. matching the data received from the user device with one part of the reference image, respectively with one among a plurality of reference images,
4. determining an annotation associated with the matching reference image;
5. sending to the device 4 an annotation in plenoptic format or an annotated image in plenoptic format.

In a various embodiment, instead of sending the captured data to a remote server 5 for matching with reference images in the server, this matching could be done locally in the user's device with a set of locally stored reference images or with a model locally stored in the device. In this embodiment, the server 5 is embarked on the user device 4. The online process can be executed several times in accordance with user's request.

The second phase of the online process may be carried out by a program code executed by a microprocessor in the device 4, which may include executable programs or other codes for causing the device 4 to carry out at least some of the following tasks:
1. receiving from a server 5 annotation data in a plenoptic format, possibly along with associated actions;
2. applying received annotation data to the captured plenoptic light field;
3. rendering the annotated light field to a user-viewable view;
4. interpreting user interactions and executing associated annotations actions.

In a various embodiment, instead of applying the received annotation to the captured plenoptic light field on the device 4, this step could be done on the server's 5 side. In this case, either the final rendered view is transmitted back to the device 4, or the entire annotated light field.

Accordingly, a user can associate annotations with a particular position and orientation with respect to a rendered view of a plenoptic reference image, and indicate one or plurality of light field parameters that the annotation should use in this specific view. A same annotation may be rendered differently depending on the viewpoint selected by the viewer during the rendering of the view. A first annotation may be replaced by a second annotation at the same location if the viewer selects a different viewpoint as the light field parameters of the annotation may change.

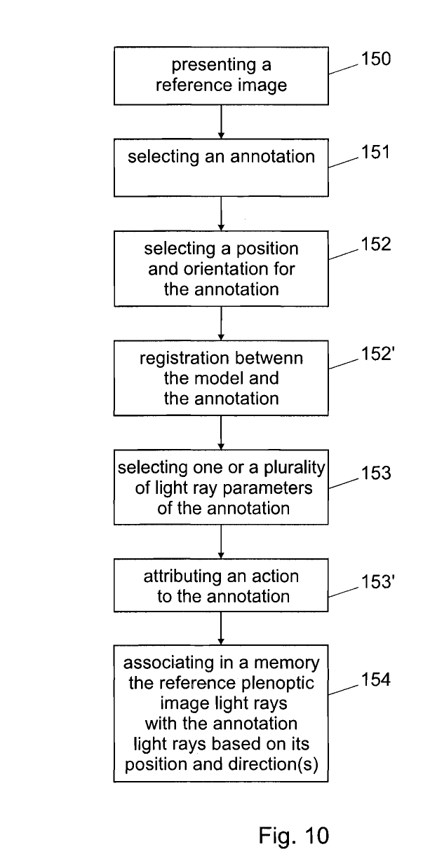

An example of flowchart for the offline process is illustrated on FIG. 10. This flowchart illustrates a method which allows a user to choose the annotation that has to be associated with a reference image, and the position, orientation and light field parameters with this annotation, so that this annotation will be applied to the captured plenoptic images matching this plenoptic reference image.

This method may use an annotation authoring system, which may be run locally in the user's device 4. The annotation authoring system may also be hosted on the server 5 where a web platform presents some tools to manage annotations and relate them to plenoptic reference images. Services, such as augmented reality usage statistics, may also be available from the web platform. The annotation authoring system may also be run in a different server or equipment, including a user's personal computer, tablet, etc.

In step 150, a user selects a reference image, such as an image in a plenoptic format. The image is uploaded on the plenoptic authoring system and serves as a support image for the annotations.

As part of the plenoptic authoring system, a viewer renders the uploaded data to the user in a way such that the user can visualize it. If the data is in a plenoptic format, which cannot be understood easily as such by a human, this might include using a plenoptic rendering module for rendering the plenoptic model in a space understandable by the user. The viewer constitutes a tool to manipulate the plenoptic data and place annotations at the desired position and orientation with respect to a given view, but all processing and combination with the plenoptic annotation are done directly in the plenoptic space.

In one embodiment, the plenoptic model can be rendered as a 2D view so that the user can visualize it from one viewpoint at a time, and with one focus distance at a time, allowing him to understand and edit the plenoptic model. To navigate from one 2D view to the other, controls are available such that upon request, another 2D view can be displayed.

In another embodiment, the plenoptic model might be rendered as a partial 3D scene, where different directions of the rays can be visualized. A major difference with standard complete 3D scene is that the 3D scene exploration is limited when rendered from a plenoptic model. For instance, the view directions as well as the view position are limited to what has been captured by the plenoptic capturing device.

In step 151, the user selects a plenoptic annotation he wants to associate with a particular element or location of the plenoptic model. As already mentioned, the plenoptic annotation is defined in the plenoptic space and thus described with light rays. Those light rays can describe for instance a text, an image, a video, or other elements directly acting on plenoptic image light rays. The plenoptic annotation may be retrieved from a library of plenoptic annotations in a database or in a file explorer for example. The plenoptic annotation can also be created on the fly, for example by capturing it with a plenoptic capturing device, by entering a text with a text editor, by drawing an image and/or by recording a sound or a video.

In one embodiment, the plenoptic annotation can be presented in a library or a list on the authoring system as previews. Plenoptic annotation previews correspond to the rendering of the annotation for a default view. This default view can be taken randomly or in a preferred embodiment, as corresponding to the middle view with respect to the plenoptic annotation range of positions and directions. The previews allow the user to get a quick and clear idea about what does the plenoptic annotation corresponds to. For general types of annotation which do not act on the model wavelength, i.e. these annotations are not visualizable as such, the preview illustrates the annotation applied to the center of the current model view rendered by the authoring system. Therefore, if this type of annotation has only the effect of rotating all model rays by 10°, the preview will be composed of the center part of the current model rendered view, where each ray has been rotated by 10°.

In step 152, the user selects with the plenoptic annotation authoring system a position in the coordinate system of the rendered view of the selected reference model at which he wants to add the plenoptic annotation. This can be done for example by dragging the annotation from the annotation preview list on top of the displayed view at the desired location, and possibly by translating, rotating, resizing, cropping and/or otherwise editing the annotation. Alternatively, the user may also enter the coordinates as values in a control panel.

In step 152′, the user can adjust the parameters of the annotation light rays to generate another view of the annotation. As the user changes the parameters of the annotation, using for example a computer mouse pointer for changing the orientation of the annotation, the light rays of the annotation are combined with light rays of the plenoptic model and a new 2D view is generated in the viewer for each new position or new orientation. This is made possible as the user mouse pointer and its movements are projected to the plenoptic space. The movement of the pointer is then applied to the annotation in the plane parallel to the virtual one corresponding to the 2D rendered view.

Once the rays of the plenoptic model and annotations are combined, the effect of the annotation is applied to the light rays of the reference image. The process of superimposing a plenoptic annotation can be seen as a process of modifying light rays. A captured plenoptic data can contain information on a direction of light rays, a wave length (i.e. color) for each light ray, thus an annotation can be considered as a modification of those parameters. For instance, attaching a text on the surface of an object can be seen as a modification of the wave length of the light rays at a specific area on the surface.

The type of effect produced by an annotation is determined by the annotation itself. In one embodiment, the plenoptic annotation is for example only composed of opaque text. In this case, the model rays wavelengths are completely replaced by the annotation rays wavelength for the mapped rays. For other annotations, by taking into account an annotation changing the texture of the model, the rays of the model may have their direction changed by the annotation in order to reflect the new texture. In yet another example, the model ray positions may be changed by the annotation.

The plenoptic annotation can be seen as a filter modifying light rays. This offers more possibilities of displaying annotated scenes. One further example of this processing is to alter the directions of light rays. As an embodiment, a glow effect can be applied to the light rays incoming from a specific object in the captured plenoptic image by adding randomness to the direction of the light rays. An annotated object can be made reflective. Another example is modification of the property of surface such as modification of texture information. Since a plenoptic annotation allows modifying the variables of light ray such as the direction and wave length, it is possible to modify the surface of an object as if a texture is added on it by combining the modifications in the variables. For instance, the plenoptic annotation enables to change a flat surface with red color to a lumpy surface with yellow color by modifying the direction and the wave length.

The information describing the effect of the annotation on the model rays may be stored in the plenoptic annotation array as will be described in step 154.

In step 153, the user selects one or a plurality of annotation light field parameters. This could be for example the wavelength of the annotation in order to change its color. The user may also define different appearances for the same annotation viewed from different directions, or even a different annotation associated to a same element viewed from different directions.

Alternatively, once successfully adjusted on the rendered plenoptic model, the user can choose to navigate to another view of the plenoptic viewer. The plenoptic annotations are automatically reported on the new view of the plenoptic model. The user can then decide to edit the annotation, change its light field parameters or appearance for this particular view. He can proceed the same way for all available views of the plenoptic model.

An interpolation process may take place between a first and a second view of the plenoptic annotation to prevent the user from having to navigate through all views of the plenoptic model. These two views of the plenoptic annotation do not have to be consecutive. The user has to specify the appearance of the annotation in the two views and the plenoptic authoring system will automatically generate the in-between views of the plenoptic annotations. Other views of the plenoptic model that have not been associated with the annotation will not display it, resulting in the possibility to not render an annotation for particular view points or focal planes of the scene.

The plenoptic annotation may comprise data corresponding to light rays and described with a set of parameters. When rendering the plenoptic annotation for a first specific view, the viewer sets some parameters and allows the user to modify the others. Navigating from this view to a second one, the user changes the parameters that have to be fixed by the viewer, while being able to modify the others. The interpolation process automatically computes the ray parameters of the plenoptic annotation between these two views.

In one embodiment, the parameters of each plenoptic annotation may be as follows: 3 (or possibly 2) parameters for the ray position in space, 2 parameters for their direction, 1 parameter for their wavelength and possibly 1 for the time. For a specific view rendered by the plenoptic viewer, the parameters of position, direction and time may for instance be set by the viewer. The user could then change the parameters not fixed by the viewer, in this example corresponding to the wavelength of the rays. Let us assume that the user sets it to a first value v1. Now, for another view of the annotation, i.e. for different values of the position, direction and time parameters, let us assume that the user changes the wavelength value for the second view, and set it for instance to v2. The interpolation process aims at computing the annotation values between v1 and v2 for views in between the position, direction and time parameters associated with the first and second views. In other embodiment, the interpolation may also consider computing values for other parameters of the plenoptic data as well, including position, direction, wavelength and/or time.

Concrete examples of interpolation include for instance a change in the color of plenoptic annotation passing for example from an orange color to a more reddish one, a change in the visibility of the annotation where for a specific view, the annotation is visible while hidden for another view.

Different methods of interpolation are possible, including for example linear, quadratic or interpolation of bigger order between the two views of the annotation. Also, more advanced interpolation methods can take into account other characteristic of the scene or of the annotation itself to generate the new rays of the annotation.

In step 153′, an action can also be associated to all or some of the annotations when the annotation is displayed on a captured image. These actions can be triggered by the user or executed automatically using for instance timers. Actions include launching a web browser with a specific URL, animating the annotations such as making one annotation move, appear or disappear, playing a video, launching a menu presenting further possible actions, launching a slide show or playing an audio file. Actions that allow the view of the plenoptic data presented to the user to be modified are also possible, for instance actions that allow to focus the view of the plenoptic data at a given focal length.

In step 154, the plenoptic annotation is stored and associated in a memory, for example in database 51 or in the user's device, with the corresponding position, orientation and with the selected reference plenoptic model. Knowing the annotations which are needed, it is possible to store in a plenoptic format the annotations attached to each reference plenoptic model. Each annotation is stored as a separate plenoptic file.

The plenoptic annotated reference data is generated from the plenoptic reference data and the corresponding one or plurality of plenoptic annotations. This augmented reality model takes the form of a file containing all the information required to render back the plenoptic model with its associated annotations. It therefore describes the relations between the plenoptic reference data and its annotations. The plenoptic annotated reference data can be rendered directly on the plenoptic annotation authoring system to pre-visualize the results, but also on the client side to render some plenoptic augmented reality.

The information describing the effect of the annotation on the model rays is stored in the plenoptic annotation data. The modification defined by the annotation acts on the model ray parameters. As a consequence, an annotation can describe for example a modification of the model light ray directions, positions, time or wavelength. In other words, this information describes a function of the model rays.

At the annotation creation, each rays of the annotation are assigned a unique identifier. When applying the annotation on the authoring system, the annotation rays unique identifiers are matched to their corresponding rays of the model. As a result, each ray of the model is assigned a annotation ray identifier which is then used by the system when it has to apply ray by ray the annotation on the model, as it is for instance mainly the case in the online phase.

The annotation information can be stored in a 2-dimensional array, where each ray contains the information about its effect on the model for each parameter. The unique identifier of the annotation rays is then used to define the corresponding ray effect in the array for each parameter. In other words, the first dimension of the array corresponds to the rays, referred by their identifier, and the second dimension to their parameters, i.e. light field parameters. Any annotation can be fully represented using this format as any modification of the model ray for any parameter can be represented in the array.

In one embodiment, an annotation can for instance modify all model rays direction by 10° for one angle. As illustrated in the table 1 hereafter, the 2-dimensional array then contains 10° in the column of the parameter corresponding to the direction angle. The column reads 10° for all rays as it is assumed they are all acting the same way. When desiring to apply the effect of the annotation on its corresponding model rays, the system will first identify the annotation and model ray pairs, extract the unique identifier corresponding to the annotation ray, look into the annotation table to see what effect this annotation ray has in order to finally apply this change to the model ray. In this example, the angle of all model rays affected by the annotation will be rotated by 10°.

TABLE 1
Annotation array.

| rays ID | x | y | z | phi | theta | time | wavelength |
|---|---|---|---|---|---|---|---|
| ray 1 ID | 0 | 0 | 0 | 10 | 0 | 0 | 0 |
| ray 2 ID | 0 | 0 | 0 | 10 | 0 | 0 | 0 |
| ray 3 ID | 0 | 0 | 0 | 10 | 0 | 0 | 0 |
| ray 4 ID | 0 | 0 | 0 | 10 | 0 | 0 | 0 |
| ray 5 ID | 0 | 0 | 0 | 10 | 0 | 0 | 0 |
| ray 6 ID | 0 | 0 | 0 | 10 | 0 | 0 | 0 |
| ray 7 ID | 0 | 0 | 0 | 10 | 0 | 0 | 0 |
| ray 8 ID | 0 | 0 | 0 | 10 | 0 | 0 | 0 |
| ray 9 ID | 0 | 0 | 0 | 10 | 0 | 0 | 0 |
| ray 10 ID | 0 | 0 | 0 | 10 | 0 | 0 | 0 |

As an example of the offline phase, the user may want to add a text annotation to a scene containing a building. Moreover, the text annotation color will need to vary from a viewpoint to another. The following step will then be done by the user:
1. A plenoptic capture of the building is uploaded to the plenoptic annotation authoring system
2. A 2D view is rendered from the captured plenoptic image and presented to the user
3. The user select the text annotation type from an annotation type list, enter his text and drag the text annotation onto the rendered 2D view
4. The user can move the viewpoint of the rendered 2D view or the annotation position and orientation so that the annotation appears exactly as the user wants.
5. The user sets the text color for the current rendered viewpoint
6. The user move the viewpoint of the rendered plenoptic image to another position
7. The user sets the text color to another value for this other viewpoint
8. The plenoptic annotation model is then saved and ready to be used for the online phase of the annotation process

The plenoptic annotation authoring system performs the following tasks to generate the proper annotation model based on the previously described user action steps for the text annotation:
1. A 2D view is rendered to the user based on the viewpoint setting initially set to a default value
2. A plenoptic version of the text annotation is generated by tracing rays from the text object to the virtual viewpoint. This creates a set of light rays, each one described by a unique identifier. This set of rays describes the text. These light rays are represented in memory by an array corresponding to the modifications which have to be applied to the reference plenoptic image. In this case, the array will contain the value of the wavelength that the light rays which are matched with the annotation light rays have to take.
3. The annotation is initially lying at a default position pre-defined in the authoring tool. The annotation light rays are combined with the reference plenoptic image rays. These relations between the rays of the reference image and the annotation are stored for future use by using the rays unique identifiers.
4. As the user moves/changes the orientation of the annotation, using for example a computer mouse pointer, the different light rays of the annotation are combined with other light rays of the captured plenoptic image and a new 2D view is generated for each position or orientation modification. This is made possible as the user mouse pointer is project into the plenoptic space. The translation of the pointer is then applied to the annotation in the plane parallel to the virtual one corresponding to the 2D rendered view. As the annotation is moved, the relations of light rays between the reference image and the annotation are changed and updated according to the annotation position or orientation change.
5. When the user selects a color for the text for the current viewpoint, the wavelength value of the annotation array is changed to match the chosen color.
6. When a new viewpoint is selected and a new text color is selected, the wavelength value of the annotation array corresponding to the light rays used to generate this new rendered view is changed. The wavelength value in-between the first viewpoint and the second viewpoint are interpolated using standard or ad-hoc interpolation methods.
7. When the user saves the model, the plenoptic annotation array is saved with the uploaded plenoptic reference model so that it can be used in the online phase.

### Online Phase

As explained previously, the online phase of the entire annotation process happens when a user capturing a plenoptic image wants that image to be annotated.

The online phase of the annotation process is applied to the input plenoptic image to get a final plenoptic annotated image. This consists of matching the input image with some reference models, retrieving the annotations of the matched reference model, combining the annotations with the input plenoptic image, rendering the annotated view to the user in an understandable form, and possibly treating user interactions in order to generate the different actions defined on the annotations.

Since the annotation content composed of light rays is in a plenoptic format and the captured image is also in plenoptic format, those two data sets lie in the same space. The annotation can thus be applied directly to the plenoptic image without further projections needed. The modified plenoptic space where the annotations have been applied to can then be projected, for example, into a 2D view. This also means that projection parameters selected for the plenoptic rendering process (such as selection of focus, depth, change of view point, . . . ) also implicitly apply on plenoptic annotations. For example, when changing the focus or viewpoint of the rendering process, the annotations will have the effects applied to them.

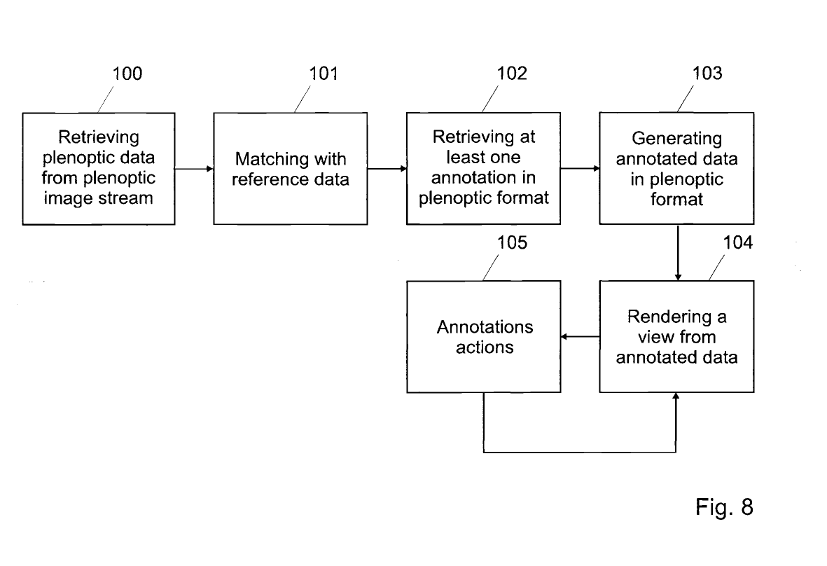

The online plenoptic annotation process, as illustrated on FIG. 8, comprises a first step 100 during which data representing a light field in plenoptic format (plenoptic data) is retrieved. The plenoptic data might be retrieved by the device 4 capturing the data with a plenoptic capturing device, or retrieved by the apparatus, such as a server 5, that receives the plenoptic data from the device 4 over a communication link.

In step 101, the retrieved data is matched with reference data. This step might be performed in the device 4 and/or in the server 5. This step might involve determining a set of features in the captured data, finding a matching reference data representing a reference image with matching features, and registering the captured data with the reference data as described for example in U.S. Ser. No. 13/645,762. The reference data may represent images in plenoptic format, or other images, and might be stored in a memory 51, such as a database, accessible from a plurality of devices. Identification of a matching reference data might be based on user's location, time, hour, signal received from elements of the scene, indication given by the user's and/or image similarities. The registration process aims at finding a geometrical relation between the user position and the reference data so that a transformation between the light rays of the captured plenoptic image and the ones from the matched plenoptic reference image can be deduced.

In step 102, a plenoptic annotation associated with the matching reference data is retrieved, for example from the memory 51. This annotation is in a plenoptic format, i.e. described with light rays. Those annotation light rays may represent for example a text, a still image, a video image, a logo, and/or other elements directly acting on plenoptic image light rays.

The annotations might include sounds in the plenoptic space, e.g., sounds attached to a specific group of rays of the plenoptic reference image, so that the sound will be played only for some directions where the selected rays are also visible and/or in focus in the plenoptic image.

In step 103, the retrieved annotation in plenoptic format is combined with the captured plenoptic data to generate annotated data representing an annotated image in plenoptic format. This combination might be made in the server 5, or in the device 4. In the latter case, the server 5 might send the annotated data to the device 4, which then makes the combination. This annotation combination is made possible as the transformation projecting the light rays of the reference image to the captured plenoptic image is known from the matching step (Step 101). The annotation can therefore be also applied to the captured plenoptic image.

The plenoptic annotations can be applied to the captured plenoptic image using the following method:
1. find a transformation for projecting reference plenoptic image light rays onto the online plenoptic image light rays retrieved in step 100 of FIG. 8;
2. for each retrieved annotation of the reference plenoptic image defined in the offline phase:
   1. by reading the annotation array defined in the offline phase, identify and select which light rays of the reference plenoptic image have to be modified according to the annotation
   2. project the light rays identified in point (1) onto the online plenoptic image. This creates a correspondence between the selected light rays of the reference plenoptic image and the ones from the captured plenoptic image.
   3. for each rays of the captured plenoptic image which have been selected at point (2), apply the transformations to the light ray as defined in the plenoptic annotation array. The array is used as a lookup-table where the light rays, which can be identified thanks to the selection process of step (1) and (2), and the parameters of the transformation (such as wavelength, directions, . . . ) are used as lookup-keys.

As an example, if the annotation light rays represent a text, the annotation array will contain a single non-null light field parameter which is the wavelength corresponding to the text color. The captured plenoptic image light rays will thus be modified by increasing/decreasing the wavelength of the rays by a factor stored in the annotation array. This factor is looked-up in the array by using the transformation between light rays computed in the registration process.

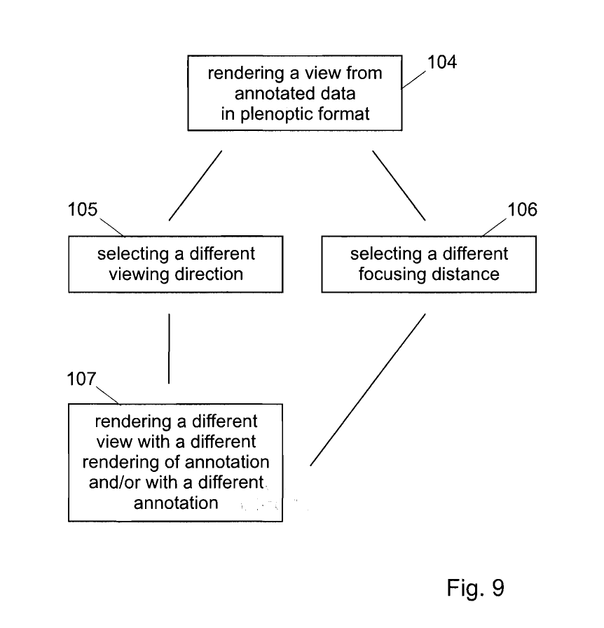

In step 104, a view is rendered from the annotated data, for example a 2D or stereoscopic view, and presented, for example displayed on display 40 or with another apparatus, to the user/viewer. This view rendering process is described in more details below in conjunction with FIG. 9.

In step 105, the interaction with the annotation is made possible. The system is capable of reacting to different events in order to execute specific actions previously defined in the offline part of the annotation process. Such an event can be a user interaction with an annotation. By the mean of a touch screen, a hand tracking sensor or any other input device, the user is able to point and interact with a given annotation. This interaction would generate an interaction event which can trigger specific actions defined in the offline phase of the annotation process.

Another possible type of event is the events triggered when a specific change in the scene is detected. As explained later in this section, an occlusion by an object of the reference model in the captured plenoptic image can be detected. This occlusion event can trigger an action previously defined in the offline phase of the annotation process. As another example of possible events triggering annotation actions, a sound recognition module can be used in order to trigger certain actions based on certain types of detected sounds.

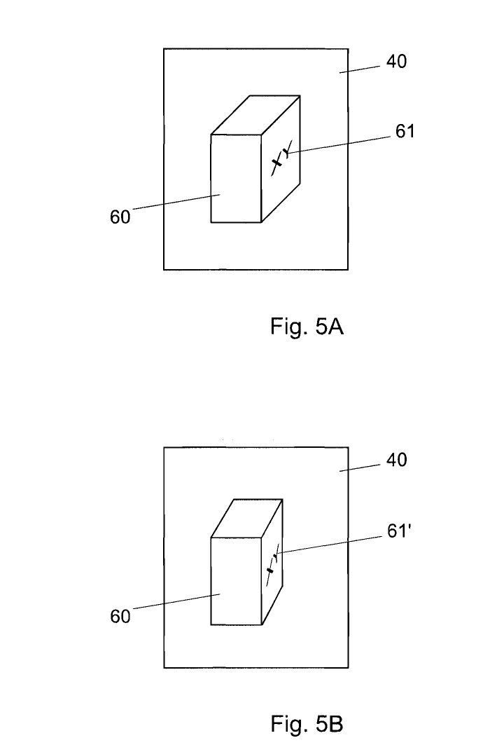

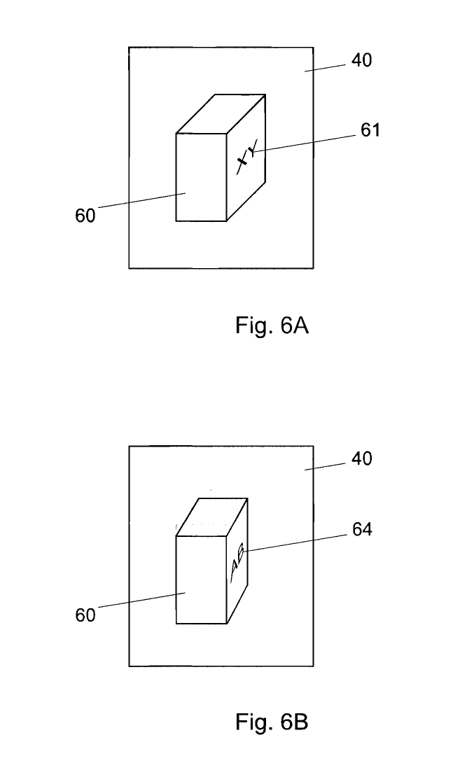

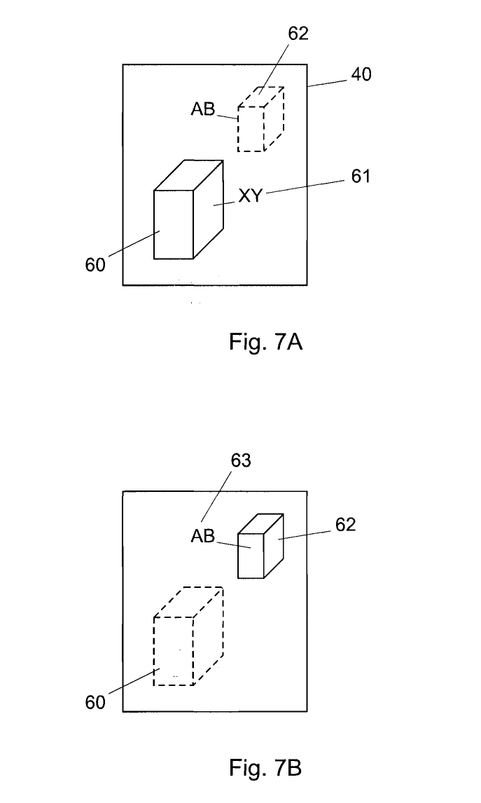

FIG. 9 illustrates the rendering of a view, and various possibilities for the viewer to modify subsequently the rendering. As previously indicated, an augmented reality view is rendered in step 104 from annotated data generated from a captured view and from annotation data in plenoptic format, as previously described with FIG. 8. The rendered view may be a standard 2D view as produced by a pin-hole camera, a stereoscopic view, a video, a holographic projection of the plenoptic data, or preferably a dynamic image module that presents an image with some commands for refocusing and/or changing the viewpoint. A dynamic image module could be an HTML5/Javascript web page able to render a plenoptic image as a function of the commands values or as a Flash object or any other technologies allowing a dynamic presentation of several images. Examples of views that may be rendered during step 104 are shown on FIGS. 5A, 6A, and 7A. The view on FIGS. 5A and 6A includes an object 60 with annotation 61. An additional object 62, at a different depth and therefore out-of-focus, is also seen on the view of FIG. 7A. Refocusing or change of viewpoint can be triggered manually by the user (for example by selecting an object or position on or around the image), or automatically (for example when the user moves).

In step 105, the user enters a command for modifying the viewpoint, in order to produce during step 107 a novel view from the same plenoptic data, corresponding to the same scene observed from a different viewpoint. Algorithms for generating from plenoptic data various 2D images of a scene as seen from different viewpoints or viewing directions are known as such, and described for example in U.S. Pat. No. 6,222,937. An example of modified 2D image produced by this command and executed by a viewpoint selection module 403 is illustrated on FIG. 5B. As can be seen, not only the perspective of the object 60 has been modified by this command, but also the perspective of the annotation 61. Indeed, since the annotation is applied directly on the plenoptic space represented by the input plenoptic data, when a view is generated from the plenoptic space, the annotation appears transformed the same way as the plenoptic image. This yields to a more realistic annotation.

Some annotations may be visible only from a first set of viewing directions, but not from other directions. Therefore, as illustrated with FIG. 6B, a change of viewpoint during step 105 may result in a new view where one annotation 61 is made invisible but a new annotation 64 associated with the same object is revealed. A plurality of annotations may be associated with a single location of the reference image, but with different viewing directions. The annotation itself might also look differently when rendered from a first viewing direction compared to second different view direction due to the different annotation light field parameter set in the offline phase of the annotation process. The change of appearance can be defined by the annotation itself but it could also be a function of the input plenoptic image.

In step 106 of FIG. 9, the user enters a command for refocusing the image and for generating from the data in plenoptic format a new image focused at a different distance. This command might be executed by a refocusing module 402. As can be seen on FIGS. 7A and 7B, this might result in a first annotation 61 visible at a first focus distance to disappear, or become less sharp, at the second focus distance shown on FIG. 7B, whereas a second annotation 63 only appears at this second focus distance.

The different commands used in step 105 and 106 to change the rendered views can also be issued automatically with respect to user movements. In one embodiment, the user movements are tracked with a Inertial Measurement Unit (IMU) embedded in the plenoptic capturing device. By using this module, the rendered view is automatically updated as user moves. For example, when the user moves on the left, the viewing direction is slightly translated to the left. The same principle is applied when a user moves forward, where the focusing range is moved also forward, yielding to sharper objects in the background planes, and softer objects at the foreground planes, compared to the previously rendered view. The present invention is not restricted to the use of an IMU to track user movements. Other means such as using directly plenoptic image content to track user movements can also be used.

In another embodiment, the online plenoptic annotation process is continuously applied to a stream of plenoptic images produced by a plenoptic capturing device of a user in movement. This continuous processing allows a user to continuously move, or to move his plenoptic capturing device, and have the plenoptic annotations updated in real time. The stream of plenoptic images has to be processed in real-time as well as the rendering of the views (step 104 of FIG. 8) so that the users perceive the annotations as if they were part of the scene. In this embodiment, the fact that the viewing direction can be modified afterwards without the need to have another plenoptic capture allows to accomplish the same effect with a much lower number of plenoptic images that needs to be processed from the stream. Indeed, if we assume that a single plenoptic capture allow the rendering of a view within a certain viewing direction range, and as long as the user doesn't move outside this range, no plenoptic image from the stream need to be processed and only the step 104 of FIG. 8 needs to be performed again. This opens up new possibilities to do a more computationally efficient real-time tracking by asynchronously processing a new plenoptic image frame when the user is getting close to the border of the viewing range so that no latencies is perceived by the user when a new frame should be processed.

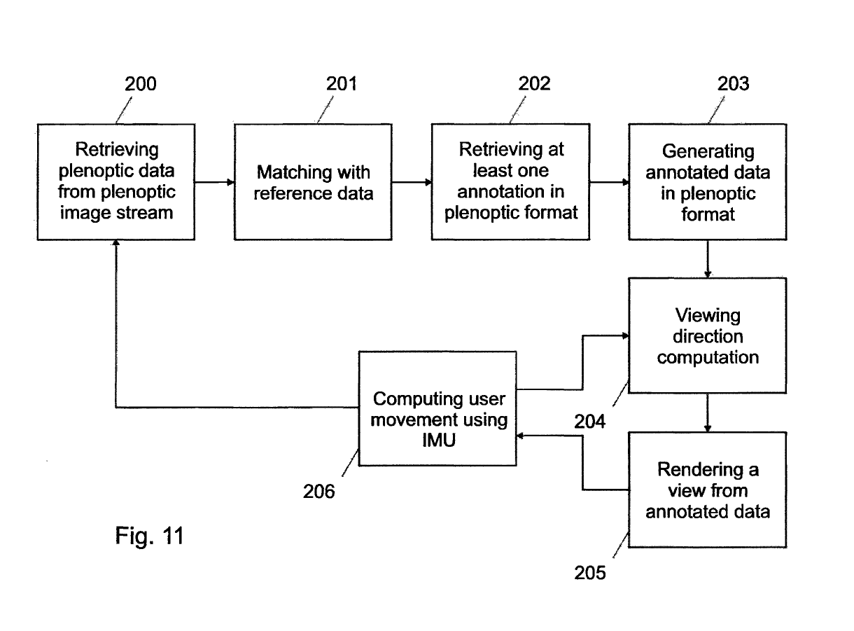

An example of a method for annotating animated plenoptic images is illustrated on FIG. 11:

The step 200, 201, 202, 203 of FIG. 20 are similar or equivalent to steps 100, 101, 102, 103 in FIG. 8.

In step 204, viewing directions parameters are computed as a result of the registration process of step 201.

In step 205, a view is rendered based on the viewing direction computed in the previous step.

In step 206, the Inertial Measurement Unit (IMU) is used to determine the user movement with respect to the time the step 200 has been computed. A decision is then taken to either go back to step 200 for processing a new plenoptic image or going directly to step 204 to update the viewing direction parameters based on the IMU movement estimation. The amount of movement is used to determine whether or not the previously captured plenoptic data can be used to generate a novel view. This typically depends on the field of view of the plenoptic capturing device.

The rendering of plenoptic annotations may consider possible occlusions. A plenoptic annotation may be occluded if the target element to annotate is hidden from the capturing device eyesight by another object lying in the input plenoptic image.

In one embodiment, the rendering module takes advantage of the plenoptic format of the captured data to visually hide the annotation behind the irrelevant object. The rendering module knows from the plenoptic reference data the properties of the captured rays that should come from each element of the captured plenoptic image. If the captured rays have different properties than the expected rays of the element, it could mean that an occluding object is in front of the element, and thus, that the annotation does not have to be displayed for this element.

In a similar way, if the rays corresponding to an element in the captured image have a different direction than the corresponding ones in the reference image, this could mean that the element is at a different depth. The rendering module could use this information to detect occlusions. Additionally, color information of rays can also be used to determine whether a captured element is occluded or not. However, the color information is not sufficient as an occluding object might have the same color as the target element.

### Applications

The provision of annotations in a plenoptic format and the process of annotating plenoptic images in the same space as the annotations bring new applications for augmented reality.

A first example of application is the use of a plenoptic annotation system in a social context. Indeed, plenoptic images of objects/scenes could be captured by users with their plenoptic capturing device. The captured plenoptic image can then be annotated by the user using all sort of annotations, including plenoptic image previously captured and used as annotation. Their annotated scene can then be shared to users' friends using social networks so that those friends can experience the annotated scene when they are capturing it with their own plenoptic capturing device. The advantage of using the plenoptic annotation process in this case is leveraged in the fact that annotations are already lying in the plenoptic space as they are plenoptic images. Therefore doing the annotation process in the same plenoptic space is more computationally efficient and yields to a more realistic annotated scene.

A second example of application, which exploits the different information of the plenoptic space, is the use of specially designed plenoptic annotations in the field of architectural design. As described in the previous parts of the invention, a plenoptic annotation is composed of light rays which are combined with the plenoptic image light rays in the online phase. The way this light rays are combined is defined in the offline part of the annotation process. This combination can be such that rays from the plenoptic image are not replaced by other light rays from the annotation, but, for example, only their direction is changed. By defining an annotation, which modify not only the wavelength of the light rays of the plenoptic image but also, for example, their directions, it is made possible to simulate a change of texture or material of the captured scene. In this case of architectural design, plenoptic annotations can be advantageously used in order to simulate how a specific room or a specific building would look with for example a different material applied to the walls. In another embodiment, simulation of weather conditions can be applied to the captured plenoptic image. An annotation simulating rain can be applied to the scene. This will yields to an annotated image with a rain effect applied to it so that user can visually see how the scene would like in case of rain or other different weather conditions, where the different light reflexions and refractions are properly handled and computed in a realistic way thanks to the plenoptic information.

As another example, treasure hunt is a popular application in conventional two-dimensional augmented reality solutions. It consists in attaching annotations to physical objects and by giving hints to friends or other people, let them search for these annotations (called treasures). In other words, when someone comes close to the hidden object, he can scan the surrounding objects with his plenoptic capturing device to determine whether they are associated with an annotation. By using plenoptic annotations, the treasure hunt becomes more exciting since we can limit the annotation visibility to some viewing directions or focus distances. For instance, a user can attach an annotation to a statue, and decide to make this annotation only visible when a future hunter is placed in front of the statue and therefore that he sees it from that angle. Similarly, we can use the refocus property of plenoptic spaces to ensure that the hunter is focused on the statue itself and hence only display the annotation in this case. It makes the treasure hunt more attractive as it avoids a user from discovering a treasure while randomly scanning the surroundings, but forces him to really solve the enigma.

Another application concerns a city guide in an urban environment. For instance, let us consider a user being in a city he visits and looking for touristic spots such as historical monuments, sightseeing points, statues, museums, local restaurants . . . . Using his augmented reality system, the user certainly doesn't want to have all information appearing at once on his screen: he would just get confused by all this content visually overlapping on the screen. Instead, the plenoptic annotations could be made dependent on the user point of view and focus. For instance, elements of an image captured by the user with a particular view angle (or in a particular range of view angle) could be displayed with a lower importance than elements which are faced by the user. In one embodiment, low importance annotations can only be displayed as titles or points on the screen (which can be extended when the user clicks on them), while more important interest points present more details or have a larger size or emphasis on the image.

The ability to select viewing directions from which annotations are not visible is attractive for vehicle drivers, who may want to get an augmented reality image on a navigator display for example, but don't want to be distracted by annotations attached to elements, such as advertising, shops etc not relevant for the traffic. In this case, those distracting annotations may be associated with a range of orientations selected so that they will not be displayed on an image captured from the road.

### TERMS & DEFINITIONS

The various operations of methods described above may be performed by any suitable means capable of performing the operations, such as various hardware and/or software component(s), circuits, and/or module(s). Generally, any operations described in the application may be performed by corresponding functional means capable of performing the operations. The various means, logical blocks, and modules may include various hardware and/or software component(s) and/or module(s), including, but not limited to a circuit, an application specific integrated circuit (ASIC), or a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration. A server may be implemented as a single machine, as a set of machine, as a virtual server, or as a cloud server.

As used herein, the expression “plenoptic data” designates any data generated with a plenoptic capturing device, or computed from other types of data, and describing a light field image of a scene, i.e., an image where not only the brightness and colour of the light is stored, but also the direction of this light. A 2D or stereographic projection rendered from such a plenoptic data is not considered to be a plenoptic image, since this direction of light is lost.

As used herein, the expression “plenoptic space” may designate a multi-dimensional space with which a light field, i.e., a function that describes the amount of light in every direction in space, can be described. A plenoptic space may be described by at least two parameters for the position of the ray two for its orientation and one for its wavelength and possibly one parameter for the time (in case of video).

As used herein, the term “annotation” encompasses a wide variety of possible elements, including for example text, still images, video images, logos, sounds and/or other elements that could be superimposed or otherwise merged into the plenoptic space represented by plenoptic data. More generally the term annotation encompasses the different way to alter the different parameters of the plenoptic space light rays represented by the plenoptic data. Annotations may be dynamic and change their position and/or appearance over time. In additions, annotations may be user interactive and react to a user's operations (e.g. move or transform upon user interaction).

As used herein, the term “pixel” may designate one single monochrome photosite, or a plurality of adjacent photosites for detecting light in different colours. For example, three adjacent photosites for detecting red, green and blue light could form a single pixel.

As used herein, the term “determining” encompasses a wide variety of actions. For example, “determining” may include calculating, computing, processing, deriving, investigating, looking up (e.g., looking up in a table, a database or another data structure), ascertaining, estimating and the like. Also, “determining” may include receiving (e.g., receiving information), accessing (e.g., accessing data in a memory) and the like. Also, “determining” may include resolving, selecting, choosing, establishing and the like.

Capturing an image of a scene involves using a digital pin-hole camera for measuring the brightness of light that reaches the image sensor of the camera. Capturing plenoptic data may involve using a plenoptic capturing device, or may involve generating the light field data from a virtual 3D model or other description of the scene and light sources. Retrieving an image may involve capturing the image, or retrieving the image over a communication link from a different device.

The expression “rendering a view”, for example “rendering a 2D view from plenoptic data”, encompasses the action of computing or generating an image, for example computing a 2D image or an holographic image from the information included in the plenoptic data.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A software module may consist of an executable program, a portion or routine or library used in a complete program, a plurality of interconnected programs, an “apps” executed by many smartphones, tablets or computers, a widget, a Flash application, a portion of HTML code, etc. A storage medium may be coupled to a processor such that the processor can read information from, and write information to, the storage medium. In the alternative, the storage medium may be integral to the processor. A database may be implemented as any structured collection of data, including a SQL database, a set of XML documents, a semantical database, or set of information available over an IP network, or any other suitable structure.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

It is to be understood that the claims are not limited to the precise configuration and components illustrated above. Various modifications, changes and variations may be made in the arrangement, operation and details of the methods and apparatus described above without departing from the scope of the claims.

1. A method comprising the steps of:
retrieving data representing a light field with a plenoptic capture device;
executing program code for matching the retrieved data with corresponding reference data;
executing program code for retrieving at least one annotation in a plenoptic format associated with an element of said reference data;
executing program code for generating annotated data in a plenoptic format from said retrieved data and said annotation.

2. The method of claim 1, further comprising:
selecting a viewing direction;
rendering a view corresponding to said annotated data from said viewing direction,
wherein the representation of said annotation depends on said viewing direction.

3. The method of claim 1, further comprising:
rendering a first view corresponding to said annotated data from a first viewing direction;
selecting a second viewing direction;
rendering a Second view corresponding to said annotated data from said second viewing direction;
wherein the representation of said annotation is changed between said first view and said second view.

4. The method of claim 1, further comprising:
associating a first annotation with a first location and a first direction;
associating a second annotation with said first location and with a second direction;
rendering a view corresponding to said annotated data,
selecting between a first or a second viewing direction;
rendering a view including said first annotation but not said second annotation if the first viewing direction is selected, or rendering a view including said second annotation but not said first annotation if the second viewing direction is selected.

5. The method of claim 1, further comprising:
rendering a first view corresponding to a reference data in a plenoptic format and to a first viewing direction;
associating an annotation to an element in said first view;
rendering a second view corresponding to said reference data in a plenoptic format and to a second viewing direction;
associating an annotation to said element in said second view;
interpolating annotations of said element in intermediate views between said first and said second viewing direction.

6. The method of claim 5, further comprising a step of computing from said first, second and intermediate views an annotation in plenoptic format.

7. The method of claim 1, further comprising:
rendering a first view corresponding to said annotated data and to a first focus distance;
modifying the focus distance;
rendering a second view corresponding to said annotated data and to the modified focus distance;
wherein the representation of said annotation is changed between said first view and said second view.

8. The method of claim 7, further comprising:
associating a first annotation with a first location and a first depth;
associating a second annotation with said first location and a second depth;
rendering a first view corresponding to said annotated data;
selecting between a first or a second focus distance;
rendering a second view including said first annotation but not said second annotation if the first focus distance is selected, or rendering a view including said second annotation but not said first annotation if the second focus distance is selected.

9. The method of claim 1, at least one of said annotations being a sound data attached to a coordinate and associated with a particular direction.

10. The method of claim 1, at least one of said annotations being a video data.

11. The method of claim 1, at least one of the annotation acting as a filter for altering the direction of light rays at a particular location in the plenoptic space.

12. The method of claim 11, wherein one said annotation modifies the directions of light rays.

13. The method of claim 12, wherein one said annotation modifies the property of the surface or texture of an object.

14. The method of claim 1, wherein said annotations are defined by an array defining direction of light rays, or modification of direction of light rays, at different point of the plenoptic space.

15. The method of claim 2, wherein rendering comprises determining when an annotation is occluded by an element of the retrieved light field, or when an annotation occludes an element of the retrieved light field, depending on the depth of said element determined from direction of light rays corresponding to said element.

16. The method of claim 2, wherein rendering comprises retrieving one annotation in plenoptic format and applying this annotation to a plurality of consecutive retrieved light fields in a stream of retrieved light fields.

17. The method of claim 2, wherein rendering comprises merging light rays of the annotation with light rays corresponding to the retrieved data.

18. An apparatus for capturing and annotating data corresponding to a scene, comprising:
a plenoptic capturing device for capturing data representing a light field;
a processor;
a display;
programme code for causing said processor to retrieve at least one annotation in a plenoptic format associated with an element of data captured with said plenoptic capturing device and for rendering on said display a view generated from the captured data and including said at least one annotation in plenoptic format when said program code is executed.

19. The apparatus of claim 18, said program code further including a refocus module allowing a user to refocus said view and for changing the presentation of said annotations depending on the selected focus distance.

20. The apparatus of claim 18, said program code further including a viewpoint selection module allowing a user to change the viewpoint used for said rendering and for changing the presentation of said annotations depending on the selected viewpoint.

21. An apparatus for determining annotations, comprising:
a processor;
a store;
program code for causing said processor to retrieve data representing a light field, to match said retrieved data with one reference data, to determine from said store an annotation in plenoptic format associated with said reference data, and to send either said annotation in plenoptic format or an annotated image in plenoptic format to a remote device when said program code is executed.

22. The apparatus of claim 21, said program code further including a module for adding annotations in plenoptic format and associating them with a position and viewing angle in said reference data.

23. The apparatus of claim 21, further comprising a memory storing annotation as an array of light ray directions, or modification of light ray directions, in different points of the plenoptic space.

24. A method comprising the steps of:
retrieving data representing a light field;
sending the retrieved data to a remote server;
receiving from said server either an annotation in plenoptic format or an annotated image in plenoptic format.

25. A method for attaching annotations to a reference image in plenoptic format, comprising:
presenting said reference image in a plenoptic format with a viewer;
selecting an annotation;
selecting with said viewer a position for said annotation and one or a plurality of directions from which said annotation can be seen;
associating in a memory said position and said directions with said annotation and said reference image in plenoptic format.

26. The method of claim 25, comprising associating a plurality of annotations with a single position but with a plurality of different directions.

27. The method of claim 25, further comprising:
rendering a first view corresponding to a reference data in a plenoptic format and to a first viewing direction;
associating a first annotation to an element in said first view;
rendering a second view corresponding to said reference data in a plenoptic format and to a second viewing direction;
associating a second annotation different from said first annotation to said element in said second view.

28. The method of claim 25, further comprising:
rendering a first view corresponding to a reference data in a plenoptic format and to a first viewing direction;
associating an annotation to an element in said first view;
rendering a second view corresponding to said reference data in a plenoptic format and to a second viewing direction;
associating an annotation to said element in said second view;
interpolating annotations of said element in intermediate views between said first and said second viewing direction.

29. An apparatus for attaching annotations to a reference image in plenoptic format, comprising:
a processor;
programme code for causing said processor to present said reference image in a plenoptic format with a viewer (150); to allow an user to select an annotation (151), as well as a position for said annotation (152) and one or a plurality of directions from which said annotation can be seen (153);
a memory storing said annotation, said position and said directions.
